(19) United States
(12) Patent Application Publication
(10) Pub. No.: US 2020/0287307 A1
(43) Pub. Date: Sep. 10, 2020

(54) REVERSIBLE JUMPER DEVICE FOR SELECTING AN ELECTRICAL PATH

(71) Applicant: PPC BROADBAND, INC., East Syracuse, NY (US)

(72) Inventors: Joshua Ivancic, East Syracuse, NY (US); Douglas Jones, Cicero, NY (US)

(21) Appl. No.: 16/808,746

(22) Filed: Mar. 4, 2020

Related U.S. Application Data
(60) Provisional application No. 62/813,952, filed on Mar. 5, 2019.

(51) Int. Cl. H01R 12/70; H01R 9/05

(52) U.S. Cl. CPC H01R 12/7041; H01R 9/0509

(57) ABSTRACT

A signal conditioning module for a cable tap may include a reversible jumper having at least one pair of U-shaped wires, a first body configured to receive the at least one pair of U-shaped wires on opposite ends within the first body and protruding through recesses within the first body; and a second body configured to cover the first body and retain the at least one pair of wires in place. The first body and the second body are configured to be connected together to form a t-shape, the first body and the second body having a set of first edges that are angled with respect to opposite second edges. A printed circuit board (PCB) includes at least two sets of contacts, wherein the PCB is configured to connect with the reversible jumper and selectively form a first electrical path of at least two electrical paths through the PCB when the reversible jumper is installed in the PCB in a first position.

### CROSS-REFERENCE TO RELATED APPLICATIONS

This application claims priority to U.S. Provisional Patent Application 62/813,952, which was filed on Mar. 5, 2019, and is incorporated herein by reference in its entirety.

### BACKGROUND

In cable-television networks, signals can be transmitted bi-directionally between a headend and potentially many remote, subscriber premises. The networks employ a variety of devices to deliver and condition such signals to enhance quality and performance of the signal transmission.

One type of device that is employed in the networks is a tap. A tap is connected to a distribution line, which continues past the tap or may be terminated at the tap. The tap also provides one or more subscriber ports. A drop cable leading to a subscriber premises may be connected to each of the subscriber ports. The tap provides a splitter, such as a directional coupler, that provides a desired level of attenuation for the signals tapped off to the subscribers (a “tap value”).

Taps can also provide signal conditioning. For example, in “return” signals proceeding from the subscriber premises toward the headend, ingress noise can be received from various sources. If left unconditioned, this noise from disparate sources can combine and affect the operation of the network, e.g., the return signal devices thereof. Additionally, signal equalization, cable simulation, and other signal conditioning characteristics may also be desirable at the taps for the “forward” signals, those signals proceeding from the headend to the subscriber. The level of attenuation and/or other conditioning characteristics best suited to the signal can change depending on the location of the tap in the network.

To provide this signal conditioning, plug-in modules have been used. These modules, however, generally require installation in the field and are susceptible to mistakes in the selection of the correct module. Further, configuration of the tap to be used at a particular location requires disassembly and reassembly of the tap to get access to the signal conditioning modules. This process is prone to error. For example, incorrect modules can be inserted. Further, misassembled taps can be susceptible to moisture or other elements that may lead to early failure of the device.

In an electrical system, an electrical path (e.g., on a printed circuit board (PCB)) may need to be changed for various reasons. As one illustrative example, in a tap, different electrical paths may be used to provide different signal conditioning.

### SUMMARY

Embodiments of the disclosure may provide a signal conditioning module for a cable tap, including a reversible jumper having at least one pair of U-shaped wires, a first body configured to receive the at least one pair of U-shaped wires on opposite ends within the first body and protruding through recesses within the first body; and a second body configured to cover the first body and retain the at least one pair of wires in place. The first body and the second body are configured to be connected together to form a t-shape, the first body and the second body having a set of first edges that are angled with respect to opposite second edges. A printed circuit board (PCB) includes at least two sets of contacts, wherein the PCB is configured to connect with the reversible jumper and selectively form a first electrical path of at least two electrical paths through the PCB when the reversible jumper is installed in the PCB in a first position.

Embodiments of the disclosure may also provide a reversible jumper including a body configured to receive first and second wires therein. The reversible jumper is configured to be installed on a printed circuit board (PCB) in either a first position or a second position. The reversible jumper may form a first electrical path when installed in the first position and forming a second electrical path when installed in the second position.

Embodiments of the disclosure may further provide a reversible jumper including a first body configured to receive at least one pair of U-shaped wires on opposite ends within the first body; and a second body configured to cover the first body and retain the at least one pair of wires in place. The reversible jumper is configured to be selectively installed on a printed circuit board (PCB) in either a first position or a second position, the reversible jumper forming a first electrical path when installed in the first position and forming a second electrical path when installed in the second position, and the PCB is configured to plug into a cable tap.

Other and different statements and aspects of the invention appear in the following claims. A more complete appreciation of the present invention, as well as the manner in which the present invention achieves the above and other improvements, can be obtained by reference to the following detailed description of a presently preferred embodiment taken in connection with the accompanying drawings, which are briefly summarized below, and by reference to the appended claims.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 illustrates an isometric view of an example embodiment of a reversible jumper in accordance with aspects of the present disclosure.

FIG. 2 illustrates a transparent isometric view of an example embodiment of a reversible jumper in accordance with aspects of the present disclosure.

FIG. 3A illustrates a front view of an example embodiment of the reversible jumper in accordance with aspects of the present disclosure.

FIG. 3B illustrates a bottom view of the example embodiment of the reversible jumper in accordance with aspects of the present disclosure.

FIG. 4A illustrates a top view of the example reversible jumper installed in a printed circuit board (PCB) in a first position in accordance with aspects of the present disclosure.

FIG. 4B illustrates a top view of the example reversible jumper installed in a printed circuit board (PCB) in a second position in accordance with aspects of the present disclosure.

FIG. 5 illustrates an isometric view of an example embodiment of a reversible jumper as described herein.

FIG. 6 illustrates an isometric view of an example embodiment of a reversible jumper as described herein.

FIG. 7 illustrates an example implementation of the reversible jumper in being used in a cable tap in accordance with aspects of the present disclosure.

### DETAILED DESCRIPTION

Embodiments of the present disclosure may provide a reversible jumper device which may be used with a component for selectively changing the electrical path on a PCB (e.g., implemented in a cable tap and/or in any other type of electrical system).

As described herein, the reversible jumper may include a two-piece plastic body that supports two rigid conductive wires. Each conductive wire may be formed in the shape of a “U” and may protrude from and underside the body and make up four prongs. These prongs are insertable into sockets formed within a PCB to form an electrical path through the wires. As further described herein, the reversible jumper may be inserted in different orientations on the PCB to connect to different sockets and form different electrical paths. For example, the reversible jumper may be inserted into the PCB in one orientation to form one electrical path. The reversible jumper may be flipped or rotated (e.g., 180 degrees) and inserted in another orientation to form a different electrical path. In this way, the electrical path may be easily selected and changed (e.g., manually by a technician or user) without the need for a switch. In some implementations, additional wires and prongs can be added to accommodate different applications for further redirection of electricity.

In one illustrative example, a PCB with selectable paths may be implemented as a plug-in module for a cable tap (e.g., a multi-tap). As described herein, the reversible jumper may be used to select the electrical path through the PCB. In some implementations, the multi-tap may include multiple signal-conditioning circuits thereon, and the PCB may be used to select between the different conditioning circuits (e.g., using the reversible jumper). For example, the signal-conditioning circuits may be selectively activated via the reversible jumper in accordance with aspects of the present disclosure. Signals received by the multi-tap may then directed to one or more subscriber ports (e.g., via one or more splitters). In some implementations, the signal-conditioning circuits may allow, for example, for a single tap to provide several different signal conditioning options. The signal conditioning options are selectable in these taps (e.g., using the reversible jumper) based upon the tap's value, as the value of the tap can have a relationship to the signal characteristics on the distribution line. In turn, this can obviate the misapplication of, and reduce inventory requirements in comparison to, plug-in modules that are commonly used today to provide different signal conditioning characteristics.

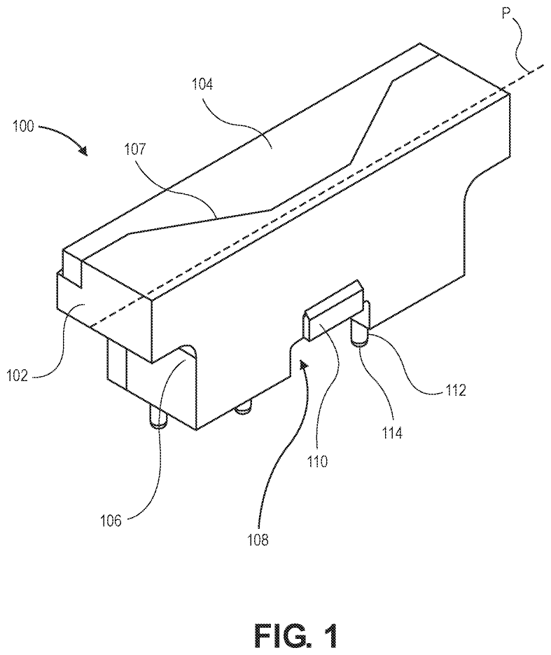

FIG. 1 illustrates an isometric view of an example embodiment of a reversible jumper 100 in accordance with aspects of the present disclosure. As shown in FIG. 1, the reversible jumper 100 may include a two-piece plastic component having two main bodies (e.g., body 102 and body 104). In some implementations, the body 102 and the body 104 may include elbow surfaces 106 on opposite distal ends to form a cutout. The body 102 and the body 104 may further include a gap 108 at a bottom surface. The body 102 may attach to the body 104 via a clasp having a hook 110. As further shown in FIG. 1, the reversible jumper 100 may include conductive wires 112 having ends 114. Each of the body 102 and the body 104 may have a set of angled edges 107 opposite of second edges along plane P (e.g., to accommodate wires 112 as further described herein). As further shown in FIG. 1, the body 102 and the body 104 may form a generally t-shape when connected together.

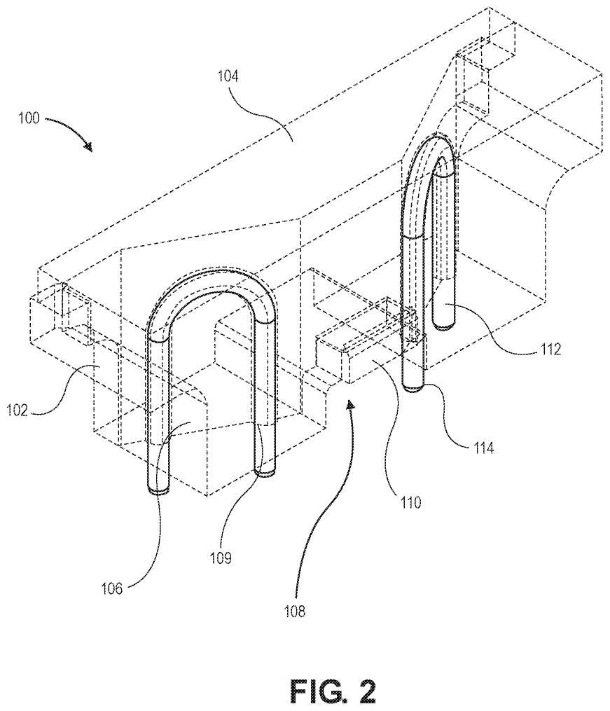

FIG. 2 illustrates an isometric view of an example embodiment of a reversible jumper 100 in accordance with aspects of the present disclosure. In this view, the main bodies 102, 104 are shown as transparent, enabling a view of the interior thereof. As shown in FIG. 2, the reversible jumper 100 may include two rigid wires 112 housed within the body 102 and retained in place by the body 104. More specifically, each wire 112 may be shaped in the form of a “U” to form rigid wire ends 114, which protrude from the bottom of the body 102 and the body 104. As shown in FIG. 2, each of body 102 and body 104 may include recesses 109 to accommodate the protrusion of each wire end 114. For example, the recesses may each be semicircular, such that when the body 102 and the body 104 are connected together, corresponding recesses align to form round holes through which the wires 112 extend. In some implementations, the wire ends 114 may be arranged at an angle. In some implementations, the wires 112 may be placed in the body 102 at opposite ends as shown, and the body 104 snaps on to the body 102 (e.g., via the clasp hook 110) to retain the wires 112 in place.

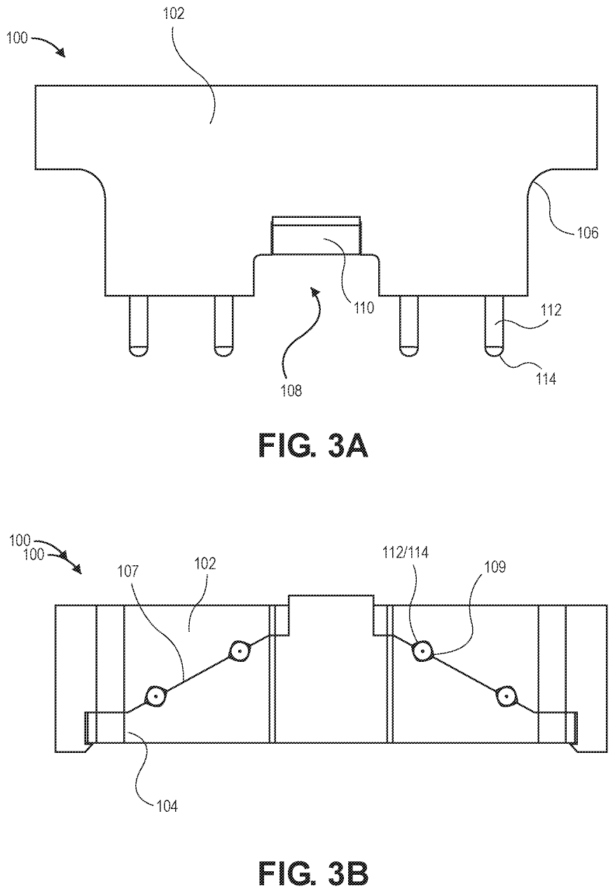

FIG. 3A illustrates a front view of an example embodiment of the reversible jumper in accordance with aspects of the present disclosure. FIG. 3B illustrates a bottom view of the example embodiment of the reversible jumper in accordance with aspects of the present disclosure. As shown in FIG. 3B, the body 102 and the body 104 each include a first edge that is relatively straight, and a set of second opposite edges 107 that are angled (e.g., to accommodate the angle in which the wires 112 are positioned). When coupled together, the body 102 and the body 104 form an angled interface as shown. As further shown in FIG. 3B, each of body § 102 and body 104 include semicircular recesses 109, which form a circular recess when the body 102 and the body 104 are attached together.

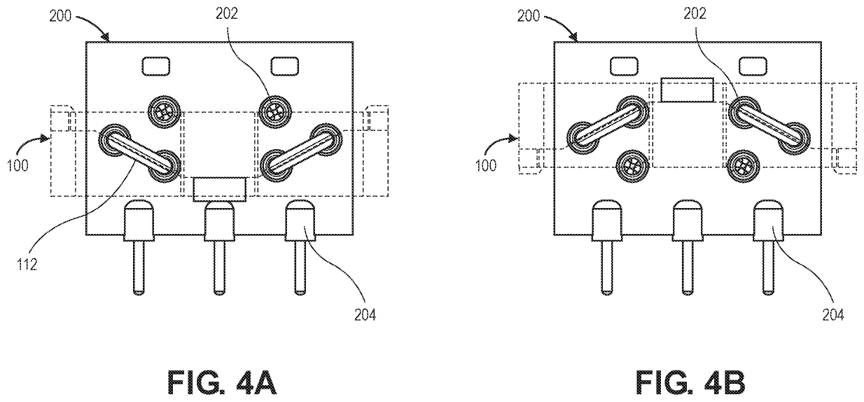

FIG. 4A illustrates a top view of the example reversible jumper 100 installed in a printed circuit board (PCB) 200 in a first position in accordance with aspects of the present disclosure. As shown in FIG. 4A, the PCB 200 may include contacts 202 and contacts 204. In an example, the contacts 202 may include sockets and the contacts 204 may include pins. In some implementations, the PCB 200 may include two sets of contacts 202, with each set having three contacts 202 for a total of six contacts 202. As shown in FIG. 4A, the contacts 202 in each set may be arranged as a triangle (e.g., an equilateral triangle), but could have any other arrangement.

In some implementations, the reversible jumper 100 may be installed in the PCB 200 in the configuration shown in FIG. 4A, thereby forming an electrical path through the wires 112 and the contacts 202 with which the reversible jumper 100 is installed. In some implementations, the PCB 200 may be plugged in to another electronic component (e.g., to a multi-tap) via the contacts 204 (which may, in an example embodiment, be pins). As an illustrative example, the PCB 200 may connect to one of two different circuits (e.g., signal conditional circuits). One of the circuits may be selectively activated based on the position of the reversible jumper 100 (e.g., based on which contacts 202 are occupied by the wire 112).

As shown in FIG. 4B, the electrical path may be selectively changed by changing the orientation in which reversible jumper 100 is installed. For example, the reversible jumper 100 may be removed from the PCB 200 and rotated (e.g., 180 degrees). The reversible jumper 100 may be installed in the orientation shown in FIG. 4B to change the electrical path. In this way, the electrical path may be easily selected and changed (e.g., manually by a technician or user) without the need for a switch.

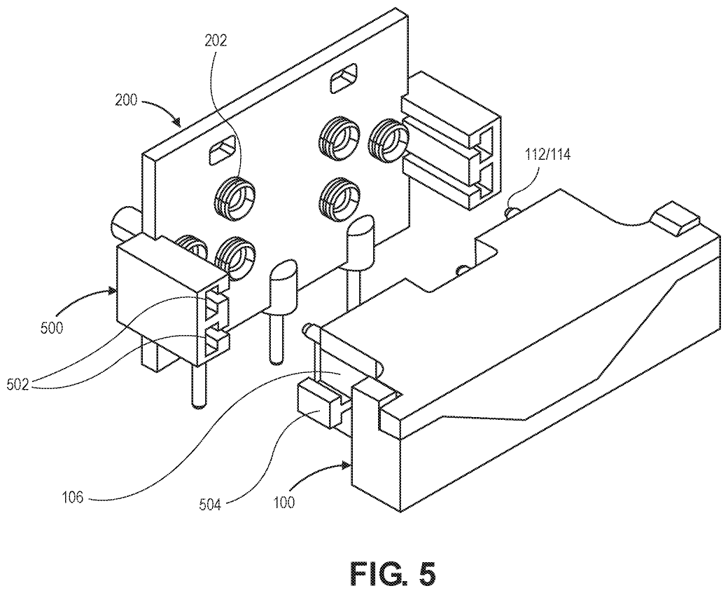

FIG. 5 illustrates an isometric view of an example embodiment of a reversible jumper 100 and the PCB 200. As shown in FIG. 5, the PCB 200 may include a pair of guide brackets 500 each having a pair of t-shaped slots 502. The reversible jumper 100 may include t-shaped keys 504 at opposite ends of the reversible jumper 100 which may be insertable into the t-shaped slots 502. The guide bracket 500 may be used to aid in guiding the reversible jumper 100 into the contacts 202 of the PCB 200. As described herein, the guide bracket 500 may be used to aid a technician and/or user to more easily align the contacts 202 with the wires 112. The t-shaped keys 504 on the reversible jumper 100 align with the t-shaped slots 502 to lock the reversible jumper 100 in place with the PCB 200.

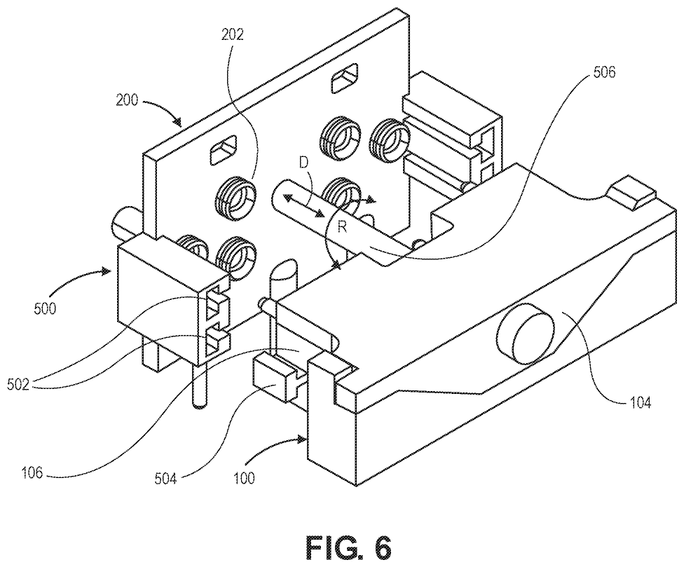

FIG. 6 illustrates an isometric view of an example embodiment of a reversible jumper as described herein. As shown in FIG. 6, the PCB 200 may include a post 506. In some implementations, the post 506 may be provided in a center of the PCB 200 and a center of the body 104. As shown in FIG. 6, the reversible jumper 100 may rotate around the post 506 (e.g., in the direction R). Further, the reversible jumper 100 may slide along an axis in the directions D as shown (e.g., so that the reversible jumper 100 may be removed from the PCB 200, rotated, and reinstalled (e.g., to change the electrical path of the PCB 200). In some implementations, the post 506 may include a biasing member (e.g., a spring) to pull the reversible jumper 100 towards the PCB 200 for a stronger engagement between the reversible jumper 100 and the PCB 200.

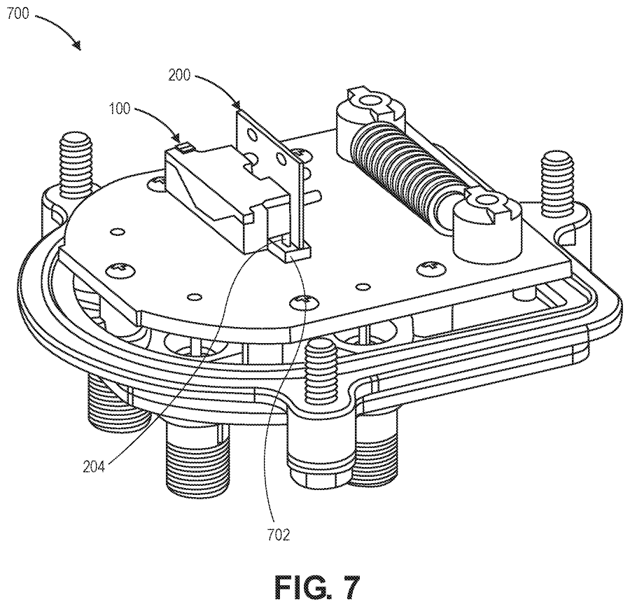

FIG. 7 illustrates an example implementation of the reversible jumper in being used in a cable tap in accordance with aspects of the present disclosure. As shown in FIG. 7, the PCB 200 may be installed into a cable tap 700. For example, the PCB 200 may be installed into a PCB of the cable tap 700 via the contacts 204. In some implementations, the PCB in the cable tap 700 may include a directional coupler and is electrically connected to subscriber ports 704. Further, the reversible jumper 100 may be installed in the PCB 200 as shown. As described herein, the reversible jumper 100 may be uninstalled, rotated, and reinstalled (e.g., to change the electrical path of the cable tap 700 (e.g., to change which signal conditioning circuit within the cable tap 700 is active). In this way, the electrical path may be easily selected and changed (e.g., manually by a technician or user) without the need for a switch.

In one or more alternative embodiments, the reversible jumper 100 and the PCB 200 may include different components and/or differently arranged components than those shown and described herein. For example, the reversible jumper 100 may include sockets instead of the ends 114. The PCB 200 may include pins instead of the contacts 202, and these pins may be insertable into the sockets of the reversible jumper 100. That is, sockets may be provided where pins are shown and described, and vice versa.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims. The present disclosure is not to be limited in terms of the particular embodiments described in this application, which are intended as illustrations of various aspects. Many modifications and variations can be made without departing from its spirit and scope, as will be apparent to those skilled in the art. Functionally equivalent apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

What is claimed is:

1. A signal conditioning module for a cable tap, the module comprising:
a reversible jumper comprising:
at least one pair of U-shaped wires;
a first body configured to receive the at least one pair of U-shaped wires on opposite ends within the first body and protruding through recesses within the first body; and
a second body configured to cover the first body and retain the at least one pair of wires in place, wherein the first body and the second body are configured to be connected together to form a t-shape, the first body and the second body having a set of first edges that are angled with respect to opposite second edges; and
a printed circuit board (PCB) comprising at least two sets of contacts, wherein the PCB is configured to connect with the reversible jumper and selectively form a first electrical path of at least two electrical paths through the PCB when the reversible jumper is installed in the PCB in a first position.

2. The system of claim 1, wherein PCB is further configured to form a second electrical path when the reversible jumper is installed in the PCB in a second position.

3. The system of claim 2, wherein the first position is 180 degrees rotated from the second position.

4. The system of claim 1, wherein each of the two sets of sockets form a triangle.

5. The system of claim 1, wherein the PCB further comprises a set of pins.

6. The system of claim 5, wherein the PCB is installed in a cable tap via the set of pins, wherein the reversible jumper electrically activates a first signal conditioning circuit when installed in the PCB in the first position and the reversible jumper electrically activates a second signal conditioning circuit when installed in the PCB in the second position.

7. The system of claim 1, wherein the PCB further includes a pair of guide brackets, each comprising a pair of t-shaped slots configured to receive a t-shaped key formed on a side of the reversible jumper.

8. A reversible jumper comprising:
a first body configured to receive at least one pair of U-shaped wires on opposite ends within the first body; and
a second body configured to cover the first body and retain the at least one pair of wires in place,
wherein:
the reversible jumper is configured to be selectively installed on a printed circuit board (PCB) in either a first position or a second position, the reversible jumper forming a first electrical path when installed in the first position and forming a second electrical path when installed in the second position, and
the PCB is configured to plug in to a cable tap.

9. The reversible jumper of claim 8, wherein the first position is 180 degrees rotated from the second position.

10. The reversible jumper of claim 8, wherein the reversible jumper electrically activates a first signal conditioning circuit in the cable tap when installed in the first position and electrically activates a second signal conditioning circuit when installed in the second position.

11. The reversible jumper of claim 8, further comprising a pair of t-shaped keys at opposite ends of the reversible jumper, wherein the t-shaped keys are configured to slide into t-shaped slots provided in guide brackets of the PCB.

12. The reversible jumper of claim 8, wherein the first position is 180 degrees rotated from the second position.

13. The reversible jumper of claim 8, wherein the first body and the second body comprise a plastic material.

14. A reversible jumper comprising:
a body configured to receive first and second wires therein,
wherein the reversible jumper is configured to be installed on a printed circuit board (PCB) in either a first position or a second position, the reversible jumper forming a first electrical path when installed in the first position and forming a second electrical path when installed in the second position.

15. The reversible jumper of claim 14, wherein the first position is 1140 degrees rotated from the second position.

16. The reversible jumper of claim 14, further comprising a clasp to couple the first body with the second body.

17. The reversible jumper of claim 14, wherein the reversible jumper is further configured to install into a cable tap to electrically activate a first signal conditioning circuit in the cable tap when installed in the first position and electrically activate a second signal conditioning circuit when installed in the second position.

18. The reversible jumper of claim 14, further comprising a pair of t-shaped keys at opposite ends of the reversible jumper, wherein the t-shaped keys are configured to slide into t-shaped slots provided in guide brackets of the PCB.

19. The reversible jumper of claim 18, further comprising a post configured to allow the reversible jumper to rotate around the post for changing the reversible jumper from the first position to the second position.

20. The reversible jumper of claim 14, further comprising cutouts at opposite distal ends and at a bottom of the reversible jumper.
